(19) United States
(12) Patent Application Publication
(10) Pub. No.: US 2013/0224364 A1
(43) Pub. Date: Aug. 29, 2013

(54) BEVERAGE WHITENING COMPOSITION AND METHOD

(71) Applicant: A.C. DISPENSING EQUIPMENT, INC., (US)

(72) Inventors: Garth C. ILLSLEY, Kentville (CA); Dennis P. DICKINSON, Dartmouth (CA)

(73) Assignee: A.C. DISPENSING EQUIPMENT, INC., Lower Sackville (CA)

(21) Appl. No.: 13/860,240

(22) Filed: Apr. 10, 2013

Related U.S. Application Data
(63) Continuation-in-part of application No. 11/687,857, filed on Mar. 19, 2007, now Pat. No. 8,420,148.
(60) Provisional application No. 60/783,417, filed on Mar. 20, 2006.

(51) Int. Cl. A23C 11/02

(52) U.S. Cl. CPC A23C 11/02
USPC 426/586

(57) ABSTRACT

A beverage whitening composition for whitening coffee, tea or hot chocolate is described. The composition replaces conventional milk in a reduced volume. The target volume for reduction is 45% to 95%. The composition comprises 0.5-80% by weight of cream having from 5-42% by weight fat; 15-97% by weight of milk having from 0.1-3.25% by weight fat; serum solids, such as skim milk powder; and optionally a stabilizer. When used in the amount of the target volume, the composition has the beverage whitening ability of the selected milk to be replaced. The composition is useful for replacing skim, 1%, 2% or whole milk in dispensers containing bags, to reduce frequency of bag replacement. The composition may be steamed and used to whiten a steamed milk beverage, such as a latte.

### CROSS REFERENCE TO RELATED APPLICATIONS

This application is a Continuation-in-Part of and claims the benefit of and priority to U.S. patent application Ser. No. 11/687,857, filed Mar. 19, 2007, the entirety of which is incorporated by reference herein, and also claims the benefit of and priority to U.S. Provisional Patent Application No. 60/783,417, filed Mar. 20, 2006, the entirety of which is incorporated by reference herein.

### FIELD OF THE INVENTION

The present invention relates generally to a beverage whitening composition. More particularly, the present invention relates to a liquid composition including primarily milk-based ingredients for whitening hot beverages such as coffee or tea.

### BACKGROUND OF THE INVENTION

The most common method of whitening a beverage such as coffee or tea is to add cream or milk. Coffee shops that dispense large volumes of cream or milk may use dispensing equipment that contains large fluid volumes. One example of such dispensing equipment is described in applicant's co-pending U.S. patent application Ser. No. 10/830,033 published as U.S. Patent Application Publication No. 2005/0236429 A1, the entirety of which is herein incorporated by reference. Control of dispensing volume may be an available feature of the dispensing equipment, having the advantage of rendering a consistent product when a customer orders, for example, a whitened beverage with “double cream”. A coffee shop using dispensing equipment will periodically need to replace the bags of cream or milk contained therein. Bag replacement frequency may be, for example, every 3 or 4 hours. This replacement frequency increases during the busiest times of the day, which can create delays in customer service.

Cream dispensed to whiten a beverage such as coffee typically contains 10% or 18% butter fat (b.f.). It is not optimal to consumer acceptance to simply substitute 20% or 35% b.f. cream, respectively, at half of the normally dispensed volume, because although the b.f. content is increased, the whitening effect attributable to non-fat milk solids is not achieved. A beverage so whitened is not as acceptable to the customer, and can clearly be distinguished from the 10% or 18% cream to which a customer may have grown accustomed.

Steamed milk is used for whitening in the preparation of specialty coffee drinks, such as cappuccinos and lattes. Further, tea-based beverages, such as Chai tea lattes or “milk tea” may be made with flavored or unflavored white, black, and green teas, or may be made with herbal teas, sometimes referred to as “tisane”. Chocolate-based drinks, such as hot cocoa, fall within the category of steamed milk beverages. Such drinks can be prepared by heating the milk with steam, instead of direct heat or microwaves, because of the reduced likelihood of burning or scalding the milk.

Creating steamed milk requires the introduction of steam to the milk until a desired temperature is met, and/or until a desired amount of foam is created. Typically, refrigerator temperature (4-6° C.) milk is heated to about 140-160° C. The resulting steamed milk has a heated fluid portion and a foam portion, the ratio of which is controlled by such variables as the amount of air introduced by the steam wand. Steam contains water vapor, and thus introduces water into milk. At higher pressures, such as can be achieved with large commercial equipment, a low water volume is introduced during the steaming process. This only minimally increases fluid volume, for example from 2 to 10%. Smaller equipment, such as machines intended for home use, introduce steam into the milk with less pressure. Thus more steaming time is required to achieve the desired heating of the milk, and fluid volume may be increased to a greater extent, For example, a fluid increase of from 5 to 40% may occur to increase the temperature from 4-6° C. to about 140-160° C.

The greater the volume of water introduced into the milk in the steaming process, the more dilute the heated milk becomes. Such dilution decreases the whitening ability of the heated milk, and reduces the taste contribution of the milk to the final drink. A steaming process that introduces water and thereby increases the fluid milk volume by 2 to 40%, will have a decrease in whitening ability that is commensurate with the dilution from steaming.

It is estimated that the fluid volume of the original milk (excluding foam) can increase from 2% to 40%, depending on the steaming process parameters, such as the equipment, and the starting and ending temperatures. The dilution of milk due to the steaming process is undesirable to the consumer, and reduces the whitening ability of the milk in the resulting hot beverage, which may be a coffee, tea or chocolate-based beverage.

Beverage whitening products other than cream or milk are available, but rarely provide the same taste and organoleptic properties as cream or milk. Customers in a coffee shop who have become used to cream or milk would not find such substitutes acceptable. Condensed milk offers a highly viscous consistency, and is not easily dispensed or dispersed into a beverage. Powdered whitener formulations are not dispensable in a liquid form, and also require additional agitation to disperse properly into a beverage.

U.S. Pat. No. 6,887,505 (Reaves et al.) teaches a milk concentrate formed through ultra-high temperature pasteurization (UHT), intended for reconstitution into a milk beverage. The concentrate is formed by evaporating liquid from a fresh milk product, which requires labor-intensive processing. In general, conventional concentrated or condensed milk products are formed in this way, by a processing-intensive step involving removal of water. Prior to reconstitution, such concentrates would not be an acceptable addition to beverages such as coffee or tea.

U.S. Pat. No. 6,627,243 (Cherian et al.) describes a cream substitute containing butter, a thickening agent, and a food protein. The cream substitute is intended for cooked or baked food products normally requiring cream, such as sauces, soups or cream-filled pastries, and requires starch or gum as a thickening agent. European Patent EP 0 714 609 B1 describes whipping cream compositions with low fat content that are suitable for preparing whipped or frozen desserts. U.S. Pat. No. 6,248,389 (Biller et al.) describes a cream substitute for addition to food recipes that require cream. The substitute is provided in a non-liquid form, such as a cube, powder, or a semi-solid (extrudable) product. Such products as these are not appropriate as whiteners for beverages.

U.S. Pat. No. 4,045,589 (Petrowski et al.) provides a non-dairy fat emulsion suitable for whitening coffee. The emulsion includes a variety of non-milk solids that would impact the taste of coffee when compared with cream. U.S. Pat. No. 6,824,810 (Sargent et al.) describes a creamer composition that may be in either liquid or powdered form containing non-dairy ingredients that are microparticulated to specified dimensions so as to prevent aggregation of particles.

Others have attempted to provide concentrated coffee products to which water can be added. U.S. Pat. No. 6,447,830 and No. 6,548,101 (both to Cevallos et al.) describe a whitened coffee concentrate that includes milk solids as well as coffee solids, which can be constituted to an appropriate strength for consumption. Patent GB 1415844 describes a whitened coffee concentrate, including a coffee extract, to which water may be added to reconstitute a coffee beverage.

There is a need for a beverage whitening composition capable of achieving taste, whitening, and organoleptic properties similar to cream or milk when added to a beverage, when delivered to the beverage in a reduced volume.

### SUMMARY OF THE INVENTION

It is an object of the present invention to obviate or mitigate at least one disadvantage of previous beverage whitening compositions, or methods of whitening a beverage.

According to an embodiment of the invention, there is provided a beverage whitening composition for replacing a selected milk in a target volume of from 45-95% of the selected milk to be replaced. The beverage to be whitened is coffee, tea, or hot chocolate, and the selected milk to be replaced is one that has a butter fat content of from 0.1-3.25%. The composition consists of: 0.5-80% by weight of cream having from 5-42% by weight butter fat; 15-97% by weight of milk having from 0.1-3.25% by weight butter fat; serum solids; and optionally a stabilizer. The composition is formulated so that the butter fat content of the composition is greater than the butter fat content of the selected milk to be replaced. The butter fat content of the composition is calculated as follows:

[Butter Fat Content Of The Selected Milk To Be Replaced]/[Target Volume].

The beverage whitening composition has the beverage whitening ability of the selected milk to be replaced when added to the beverage in the target volume of from 45-95% of the volume of the selected cream or milk to be replaced.

Further, there is described herein a method of whitening a beverage, comprising adding to the beverage the composition herein described, in the amount of the target volume. This allows for the consistent whitening a consumer may have come to expect with a conventional milk (such as skim, partially skimmed 1% or 2% milk, or whole milk) but in a reduced volume.

There is also provided herein a method of formulating a beverage whitening composition for replacing a selected milk in a target volume of from 45-95% of the selected milk to be replaced. The beverage to be whitened is coffee, tea, or hot chocolate, and the selected milk to be replaced has a butter fat content of from 0.1-3.25%. The method comprises: determining the selected milk to be replaced; and forming, in the target volume of from 45% to 95% of the selected milk to be replaced, the composition consisting of: 0.5-80% by weight of cream having from 5-42% by weight butter fat; 15-97% by weight of milk having from 0.1-3.25% by weight butter fat; serum solids; and optionally a stabilizer. In the composition so formulated, the butter fat content of the composition is greater than the butter fat content of the selected milk to be replaced, and is calculated as:

[Butter Fat Content Of The Selected Milk]/[Target Volume].

The beverage whitening composition has the beverage whitening ability of the selected milk to be replaced when added to the beverage in the target volume of from 45-95% of the volume of the selected cream or milk to be replaced.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 is a graphic depiction of parameters to be considered according to an embodiment of the invention.

### DETAILED DESCRIPTION

Generally, the present invention provides a composition and method for whitening a beverage. The beverage to be whitened may be any drink that is served hot or cold to which cream or milk may be added. Examples of beverages to which cream or milk are traditionally added include coffee and tea.

As used herein, the term serum solids refers to non-fat solids, typically isolated from milk, but which may also be isolated from other non-milk sources. Examples of serum solids include skim milk powder, isolated non-fat milk components such as milk protein, and whitening products that may be from plant-based sources such as from soy. The term MSNF (milk solids, non-fat) may be used to indicate serum solids derived from milk sources.

The term “reduced-volume” refers to a reduction in the fluid volume of the beverage whitening composition versus the cream or milk to be replaced, such as conventional skim, partially skimmed, or whole milk. The volume may be reduced to a “target volume” that ranges from 45% to 95% of the cream or milk to be replaced, so that the volume of the beverage whitening composition needed to achieve the same whitening effect of 1 Litre of the cream or milk to be replaced is from 450 mL to 950 mL, and preferably from 60% to 85% (600 mL to 850 mL).

As described herein, a target volume is defined as a percentage of the volume of the cream or milk to be replaced. The target volume is a reduced volume compared to the amount of cream or milk to be replaced that is required to achieve the same whitening effect. For example, if the target volume for the composition is 80% of the volume of the milk to be replaced, this means that for a volume of 1000 mL of milk to be replaced, the comparable volume of beverage whitening composition according to the invention would be 800 mL. The target volume of 80% results in a reduced volume of 800 mL, compared to the 1000 mL of milk that would have otherwise been required to achieve the same beverage whitening effect, or in order to achieve a beverage whitening effect that is indistinguishable to a consumer of a beverage so whitened.

Subjective or objective evaluation of the whitening ability of a composition may be undertaken based on evaluation of whitened samples of the composition versus a control. For example, a consumer (or panel of consumers) could be utilized to evaluate a whitened beverage based on visible qualities. Such a consumer or panel may also be utilized to evaluate consumer acceptance. If a consumer or consumer panel determines a composition to be indistinguishable from the cream or milk to be replaced, then it could be said that such a composition has the same whitening ability as the cream or milk it was designed to replace. Such an evaluation of acceptance may be undertaken on the basis of one or more parameters. While the visual effect of whitening is an important parameter, consumers can also evaluate the effect a beverage whitener has on the taste of a product, which encompasses other organoleptic properties such as the mouth feel of a product. Such organoleptic properties can be influenced by such factors as the density or fat content of a whitened beverage.

Evaluation of whitening effect can also be undertaken by comparing measurements or data collected on beverages whitened with the composition (test samples) versus those whitened using the cream or milk to be replaced (control sample). The Zahn cup measurement test, as described below in the Examples, can be utilized. Color matching can be done using standardized color chips. Colorimeter evaluation of color intensity using instrumentation such as the Vernier Colorimeter (Vernier Software & Technology of Beaverton, Oreg.) or other spectrophotometric technologies can be utilized to evaluate whether a composition has a comparable whitening ability to the cream or milk it is designed to replace.

Aside from target volume, most other quantitative amounts discussed herein are determined on a % wt/wt basis. For example, for butter fat content, or quantities of the components that make up the composition, these are generally given on a % wt/wt basis, as indicated.

The term “b.f.” is used herein to mean butter fat.

The term “beverage whitening ability” refers to the lightness of color of a beverage to be whitened using cream or milk. This parameter can be evaluated using visual inspection, for example by a human subject who may be planning on consuming the whitened beverage, or can be determined using instrumentation capable of measuring color-related parameters. Adequate similarity in beverage whitening ability, as would be understood by a person of skill in the art, is deemed to be a level that is either indistinguishable, or acceptably distinguishable to a consumer who may be planning on consuming the whitened beverage. For example, the ability for 18% b.f. cream to whiten a beverage is unacceptably distinguishable to such a consumer in whitening ability as compared with skim milk. A consumer wishing to consume a coffee beverage whitened to the level obtainable by cream would deem this difference to be unacceptably distinguishable.

Beverage whitening ability depends on both the butter fat content and the serum solids content. Thus, for example, if the butter fat content alone is doubled in a cream product, it cannot be used in half the volume to achieve the same beverage whitening ability as the original volume of cream to be replaced. In other words, 10 mL of 20% cream does not have the same beverage whitening ability as 20 mL of 10% cream. As a further example, if the serum solids content alone is doubled in a milk product, it cannot be used in half the volume to achieve the same beverage whitening ability as the original volume of milk to be replaced. In other words, 20 mL of milk will not have the same beverage whitening ability as 10 mL of milk which has been formulated to have double the serum solids volume. The invention is founded on the findings that both serum solids and fat content must be adjusted in order to achieve the same beverage whitening ability, as well as on careful experimentation to develop and optimize compositions able to achieve this objective.

In one embodiment, a beverage whitening composition is provided for replacing cream or milk in a reduced volume comprising: cream having a higher butter fat content than the cream or milk to be replaced; milk having a lower butter fat content than the cream or milk to be replaced; and serum solids. The composition has the beverage whitening ability of the cream or milk to be replaced in a target volume of from 30% to 95% of the volume of cream or milk to be replaced. In other words, a volume of from 300 mL to 950 mL of the composition, depending on the selected target volume, would have the beverage whitening ability of 1 Litre or the cream or milk to be replaced.

Replacing a selected milk in a reduced volume can be achieved, as described herein when the selected milk to be replaced is a conventional milk such as whole milk (3.25% b.f.), partially skimmed milk (for example 2% or 1% b.f.) or skim milk (0.1% b.f.), or alternatively with a less conventional type of milk having a butter fat content less than 5%. Conventional milks are typically produced by dairies without dilution, evaporation or re-constitution of the milk with water, and are thus referred to herein interchangeably as conventional milks or conventional milk products, or simply as “milk”. When the term “milk” or “cream” is used herein without an adjective, it is generally used to describe a conventional milk or cream, such as one that is produced ubiquitously by dairies, and is widely commercially available. Conventional milk is typically the type of milk to which consumers have grown accustomed. The standard or conventional amounts of butter fat in such milks or creams are those which consumers are used to, and encompass a variety of butter fat percentages depending on consumer preference. Thus, when such milks are referred to herein as “the milk to be replaced” or “conventional milk”, the distinguishing name of the product is typically employed as “whole milk”, “partially skimmed 2% milk”, “partially skimmed 1% milk”, or “skim milk”. In each case, a tailored composition can be prepared as described herein, so as to reduce the target volume to a desired, pre-determined level while still achieving the desired whitening ability when added to a hot beverage, such as coffee, tea, or a chocolate beverage like hot chocolate. It is primarily convention and consumer familiarity that determines the percentage of butter fat present in milk, and thus milk products contain different amounts of butter fat. However, a partially skimmed milk containing an alternative percentage, such as 1.5% butter fat, is also a type of milk that could be replaced in a reduced volume according to the inventive composition described herein. It is for convenience that the examples described herein primarily relate to a reduced volume composition for replacement of the 4 most popular and consumer-accepted milks: whole, partially skimmed 1%, 2%, and skim milk.

When referred to herein, “cream” is meant to refer to fluid milk-based products having 5% butter fat or higher, up to and including very high fat creams of 45% fat.

When so formulated, the composition contains from 105% (100/95) to 333% (100/30) wt/wt of the butter fat content of the cream or milk to be replaced. The butter fat content of the composition may be calculated as the inverse of the target volume.

Further, the total non-fat solids content of the composition may be from 105% (100/95) to 333% (100/30) wt/wt of the non-fat milk solids content of the cream or milk to be replaced. The total non-fat solids content of the composition may be calculated as the inverse of the target volume.

The butter fat content of the composition (as % wt/wt) may be calculated as F_{T}=(F_{C}×Q_{C})+(F_{M}×Q_{M}) wherein F_{C} is the % wt/wt butter fat content of the cream, Q_{C} is the % wt/wt of the composition attributable to cream, F_{M} is the % wt/wt butter fat content of the milk, and Q_{M} is the % wt/wt of the composition attributable to milk.

The total non-fat solids content of the composition may be calculated as S_{T}=(S_{C}×Q_{C})+(S_{M}×Q_{M})+(Q_{P}) wherein S_{C} is the % wt/wt non-fat milk solids content of the cream, Q_{C} is the % wt/wt of the composition attributable to cream, S_{M} is the % wt/wt non-fat milk solids content of the milk, Q_{M} is the % wt/wt of the composition attributable to milk, and Q_{P} is the % wt/wt of the composition attributable to serum solids.

Cream may comprise from 1 to 90% wt/wt of the composition, the cream component having from 5 to 40% wt/wt butter fat. Milk may comprise from 1 to 90% wt/wt of the composition, the milk component having from 0 to 4% wt/wt butter fat. Serum solids may comprise from 1 to 30% wt/wt of the composition.

An exemplary composition may have 30% wt/wt whole milk having 3.25% wt/wt butter fat, 67% wt/wt cream having 42% wt/wt butter fat, 2.7% wt/wt serum solids, and 0.3% wt/wt stabilizer. Further, another exemplary composition may have 28% wt/wt skim milk, 69% wt/wt cream having 42% wt/wt butter fat, 2.7% wt/wt serum solids, and 0.3% wt/wt stabilizer.

Skim Milk as the Milk to be Replaced.

When skim milk is the selected milk to be replaced, a relatively low content of butter fat must nevertheless be maintained in the composition. The whitening effect of skim milk can be attributable in part to serum solids, and thus, and increase in serum solids that is commensurate with the increase in the butter fat content of the composition (versus skim milk) may be used. However, the increase in serum solids may be proportionally less than the increase in butter fat.

When the selected milk to be replaced is skim milk having a butter fat content of 0.1% wt/wt, an exemplary composition may consist of 0.5-2.0% by weight of cream having 5% by weight butter fat; 88-97% by weight of milk having 0.1% by weight butter fat (skim milk); serum solids; and optionally a stabilizer. The serum solids may be added in an amount of from 1% to 10%, and preferably at a level of from 2% to 7%. In general, the larger the target volume is, the less of the serum solids is needed in the composition to emulate the whitening ability of skim milk.

A specific exemplary composition is a reduced-volume skim milk replacement composition. The composition comprises 94% skim milk (containing 0.1% wt/wt butter fat), 1% cream (containing 5% wt/wt butter fat), 4.7% wt/wt serum solids, and 0.3% wt/wt stabilizer. In this way, the reduced-volume skim milk replacement composition has the whitening effect of commercial skim milk in a target volume that is about ⅔ (67%) of the volume of the skim milk to be replaced.

This reduced-volume skim milk replacement composition comprises about 0.15% wt/wt butter fat (compared with conventional skim milk containing 0.1%) and 14% (wt/wt) serum solids. Specifically: 4.7 g serum solids/100 g of composition is contributed by direct addition of serum solids, 9.4 g serum solids/100 g of composition is contributed by the skim milk component, and 0.1 g serum solids/100 g of composition is contributed by the cream component. These values are based on skim milk comprising about 10% serum solids while cream containing 5% butter fat comprises about 9.5% serum solids. Thus, the target volume for this reduced-volume skim milk replacement composition is about 67%. Additional exemplary compositions are described below in the Examples.

Partially Skimmed Milk as the Milk to be Replaced.

When the selected milk to be replaced is partially skimmed milk, for example having a butter fat content of 1% wt/wt, the composition may consist of 5-25% by weight of cream having from 5-42% by weight butter fat (for example, from 5 to 18% butter fat); 70-95% by weight of milk having from 0.1-2% by weight butter fat; serum solids; and optionally a stabilizer. When the selected milk to be replaced is partially skimmed milk having a butter fat content of 2% wt/wt, the composition may consist of 3-70% by weight of cream having from 5-42% by weight butter fat (for example, from 5 to 35% butter fat); 55-95% by weight of milk having from 0.1-3.25% by weight butter fat; serum solids; and optionally a stabilizer. The serum solids may be added in an amount of from 1% to 10%, and preferably at a level of from 2% to 7%. In general, the greater the target volume (as a percentage), the less of the additional serum solids is needed in the composition to emulate the whitening ability of the selected milk to be replaced.

An exemplary composition is a reduced-volume partially skimmed 1% milk replacement composition, for replacement of conventional 1% butter fat milk in a target volume of 70%. Thus, 70 mL of this partially skimmed milk replacement composition possesses the whitening ability of 100 mL of conventional partially skimmed 1% milk. The composition comprises 82% skim milk (containing 0.1% wt/wt butter fat), 14% “half and half” cream (containing 10% wt/wt butter fat), 3.7% wt/wt serum solids, and 0.3% wt/wt stabilizer. In this way, this reduced-volume partially skimmed 1% milk replacement composition has the whitening effect of conventional partially skimmed 1% milk in a target volume that is about 70% of the volume of the milk to be replaced.

This reduced-volume partially skimmed 1% milk replacement composition comprises about 1.4% wt/wt butter fat (compared with conventional partially skimmed 1% milk containing 1%) and 13% (wt/wt) serum solids. Specifically: 3.7 g serum solids/100 g of composition is contributed by direct addition of serum solids, 8.2 g serum solids/100 g of composition is contributed by the skim milk component, and 1.2 g serum solids/100 g of composition is contributed by the cream component. These values are based on skim milk comprising about 10% serum solids while cream containing 10% butter fat comprises about 9% serum solids. Thus, the target volume for this reduced-volume partially skimmed 1% milk replacement composition is about 70%.

Another exemplary composition is a reduced-volume partially skimmed 2% milk replacement composition, for replacement of conventional 2% butter fat milk in a target volume of 55%. Thus, 55 mL of this partially skimmed 2% milk replacement composition possesses the whitening ability of 100 mL of conventional partially skimmed 2% milk. The composition comprises 77% partially skimmed 1% milk (containing 1% wt/wt butter fat), 16% “coffee cream” (containing 18% wt/wt butter fat), 6.7% wt/wt serum solids, and 0.3% wt/wt stabilizer. In this way, this reduced-volume partially skimmed 2% milk replacement composition has the whitening effect of conventional partially skimmed 2% milk in a target volume that is about 55% of the volume of the milk to be replaced.

This reduced-volume partially skimmed 2% milk replacement composition comprises about 3.6% wt/wt butter fat (compared with conventional partially skimmed 2% milk containing 2%) and 16% (wt/wt) serum solids. Specifically: 6.7 g serum solids/100 g of composition is contributed by direct addition of serum solids, 7.6 g serum solids/100 g of composition is contributed by the partially skimmed 1% milk component, and 1.3 g serum solids/100 g of composition is contributed by the cream component. These values are based on partially skimmed 1% milk comprising about 10% serum solids while cream containing 18% butter fat comprises about 8% serum solids. Thus, the target volume for this partially skimmed 2% milk replacement composition is about 55%.

Whole Milk as the Milk to be Replaced.

When the selected milk to be replaced is whole milk having a butter fat content of 3.25% wt/wt, the composition may consist of 3-80% by weight of cream having from 5-42% by weight butter fat; 15-95% by weight of milk having from 0.1-3.25% by weight butter fat; serum solids; and optionally a stabilizer. The serum solids may be added in an amount of from 1% to 10%, and preferably at a level of from 2% to 7%. In general, the greater the target volume (as a percentage), the less of the additional serum solids is needed in the composition to emulate the whitening ability of the selected milk to be replaced.

An exemplary composition is a reduced-volume whole milk replacement composition, for replacement of conventional whole milk comprising about 3.25% butter fat in a target volume of 65%. Thus, 65 mL of this whole milk replacement composition possesses the whitening ability of 100 mL of conventional whole milk. The composition comprises 76% partially skimmed 2% milk (containing 2% wt/wt butter fat), 19% “coffee cream” (containing 18% wt/wt butter fat), 4.7% wt/wt serum solids, and 0.3% wt/wt stabilizer. In this way, this reduced-volume whole milk replacement composition has the whitening effect of conventional whole milk in a target volume that is about 65% of the volume of the milk to be replaced.

This reduced-volume whole milk replacement composition comprises about 4.9% wt/wt butter fat (compared with conventional whole milk containing 3.25%) and 14% (wt/wt) serum solids. Specifically: 4.7 g serum solids/100 g of composition is contributed by direct addition of serum solids, 7.6 g serum solids/100 g of composition is contributed by the partially skimmed 2% milk component, and 1.5 g serum solids/100 g of composition is contributed by the cream component. These values are based on partially skimmed 2% milk comprising about 10% serum solids while cream containing 18% butter fat comprises about 8% serum solids. Thus, the target volume for this reduced-volume whole milk replacement composition is about 65%.

An exemplary target volume may be from 45% to 95%, and a more specific exemplary range for the target volume may be from 60 to 85% of the volume of cream or milk to be replaced. For example, an 18% wt/wt butter fat cream may be replaced in a target volume of 60% so that 600 mL of the composition according to the invention can replace 1 Litre of the 18% cream and still maintain the beverage whitening ability.

The invention also provides a method of whitening a beverage comprising adding to the beverage the inventive composition described herein. Such a beverage requires only the target volume of the inventive composition to be added to achieve the desired effect, which allows a reduced volume to be dispensed into the beverage, compared to using cream or milk.

The invention further provides a method of formulating a beverage whitening composition for replacing cream or milk in a reduced volume comprising the step of combining cream having a higher butter fat content than the cream or milk to be replaced; and milk having a lower butter fat content than the cream or milk to be replaced; with serum solids, so that the composition has the beverage whitening ability of the cream or milk to be replaced in a target volume of from 30% to 95% of the volume of cream or milk to be replaced.

The following procedure may be followed in order to determine an optimal composition to meet the needs of any particular application. In order to formulate a composition that meets the needs of an end-user of the composition, the desired reduction in fluid volume should be considered, so that a “target volume” may be selected. For example, if a typical sized container of 10 L of a conventional milk has been in use previously, the end-user may wish to reduce this container to the somewhat smaller size of for example 8 L or 6 L for ease of handling by workers, or may instead wish to utilize the same size of container, but with the composition being contained therein instead of the conventional milk to be replaced, such a container could be used to dispense the whitening composition into additional beverages, thereby reducing the frequency with which the container needs replacing. For example, in the case of a target volume selected as 80%, the same size (10 L) container of the beverage whitening composition would whiten 25% more beverages than a 10 L container of the conventional milk to be replaced. In the case of a target volume selected as 60%, the same container of the beverage whitening composition would whiten 66% more beverages before needing to be replaced. Efficiencies and/or optimization in the workplace can lead to better service, for example in a typical busy coffee shop, as well as to cost savings.

In the event where automated equipment is used to dispense the composition into the beverage to be whitened, the set dispensing volume for the equipment could be reduced by an amount commensurate with the target volume. For example, if a coffee with “double milk” is ordered by a customer, and using conventional milk this would translate into the dispensing of 10 mL of milk into a 250 mL beverage, the use of the composition having an 80% target volume would allow the equipment to be adjusted to dispense 8 mL of the whitening composition (when the target volume of the composition is selected as 80%), as opposed to the 10 mL of conventional milk, while still maintaining consistent whitening of the beverage, so that the change from milk to the whitening composition is imperceptible to regular customers who frequent the establishment. Similarly, when the target volume of the composition is selected to be 60%, automated equipment could be adjusted to dispense 6 mL of the whitening composition for a whitening effect that is imperceptibly different to a consumer when compared with 10 mL of the conventional milk to be replaced.

In instances where the consumer adds her own milk to whiten a beverage, there are a number of advantages to using the beverage whitening composition. In many coffee shops, only small quantities of milk are left in an accessible concession area for a consumer to utilize. For example, while milk may be obtained by the establishment in large quantities, such as a 10 L container, a smaller carafe of 1 L or less may be utilized in the concession area where the customer adds sugar, sweetener, cream or milk. The consumer adds the milk (or cream) to which they have become accustomed, but the amount dispensed is not measured. Rather, the customer meters out the milk based primarily on visual whitening effect. There are rarely any measuring utensils available, and customers generally do not attempt to measure the fluid volume at a typical coffee shop concession are. The consumer typically pours in the milk directly from the carafe to her cup without the use of an intermediate measuring device, such as a spoons or measuring cup. As soon as the desired whitening effect is visibly determined as accomplished, the consumer ceases pouring. In such a case, the beverage whitening composition will achieve the desired visual whitening effect in a smaller volume than would be needed using the conventional milk to which the consumer has grown accustomed. Thus using primarily this visual cue, the consumer will voluntarily, albeit possibly unknowingly, use a smaller volume to achieve the same whitening effect.

This has the advantage of requiring less frequent replenishment of the milk or cream in the concession area.

The milk conventionally added to coffee or tea by the user at a concession area of a coffee shop is typically kept cold using an insulated carafe, by proximity to ice, or simply due to recent refrigerated storage. Thus the conventional temperature of the milk to be added may range from refrigeration temperature (4° C.) to ambient room temperature (20° C.), which is colder than the hot beverage to be whitened. Keeping the milk at a cold temperature is desirable to prevent spoilage or souring of the milk, if it is left out for longer periods of time during less busy times of day. Thus, the addition of a smaller volume of this whitening composition will have less impact on lowering the temperature of the beverage to be whitened.

When consumers are utilizing smaller volumes of such a compositions to achieve the same whitening effect, this means that such a carafe that is kept in a concession area would not require as frequent replacement. During busy times of day, the frequency with which the carafe must be replaced or re-filled increases, just as the staff of the establishment become busy with an increased customer volume. By filling the carafe with the beverage whitening composition, the customer will not require as much volume to achieve the same whitening effect as is accomplished with the conventional milk to which they have become accustomed.

Once a milk to be replaced has been selected, the composition may be formulated according to the convenience and availability of ingredients. For higher fat compositions, more options are available for potential formulations. Specifically, if whole milk is selected as the milk to be replaced, the milk used in the composition may be skim, 1%, 2%, or even whole milk itself. The higher the fat content of the milk, however, the less of the fat content is required to come from cream. When a low fat milk is used in a composition formulated to replace whole milk, then a higher fat cream may be used in the formulation to achieve the right balance of fat in the composition itself, in order to satisfy the equation that calculates the butter fat content of the composition: [butter fat content of the selected milk]/[target volume].

The availability of cream and milk components, and cost considerations may be used in determining the optimal ingredients to be used in formulating the composition. For example, if skim milk is a particularly cost-effective ingredient on a volume basis, by comparison with 2% milk, for example, then a composition designed to replace whole milk (3.25% b.f.) in a target volume of 70% could be formulated to optimize the contribution of skim milk. A high fat cream could thus be selected, for example a 40% b.f. cream. Given these parameters, the beverage composition would need to be formulated to have a total fat content of about 4.6% (specifically calculated as 3.25% b.f.÷ 70%). When skim milk is used as the milk in the composition, 84.5% skim milk is used with 11.3% high fat cream (40% bf), 4% serum solids, and 0.2% stabilizer, for example. This results in a composition containing 4.6% butter fat, and which can achieve the same whitening effect as whole milk in about 70% of the volume of whole milk. Provided the butter fat content of the milk and cream are adequately selected to contribute to the total butter fat content desired in the composition, it does not matter which component (milk or cream) is the primary contributor to the total fat content of the composition.

In the event that skim milk is a not the most economical choice for formulating the composition, and whole milk was to be the most cost-effective or readily available type of milk, a composition could be formulated as follows to achieve the same result: whitening with the same effect as whole milk, but in 70% of the volume. The composition could be formulated with a lower fat cream, such as coffee cream at 18% b.f. An exemplary composition thus could be 86% whole milk, 9.8% coffee cream, 4% serum solids, and 0.2% stabilizer.

Further, if whole milk is a highly economical choice, and high fat cream (40% bf) is also a preferred choice of ingredients, a different formulation could be considered, such as: 92% whole milk, 3.5% high fat cream (40% b.f.), 4% serum solids, and 0.2% stabilizer.

To further illustrate the variety of formulations possible to achieve the same effect, a formulation prepared with skim milk and half-and-half (10% b.f.) cream could be formulated as follows: 50% skim milk, 45.8% half-and-half cream, 4% serum solids, and 0.2% stabilizer. This also results in a composition having 4.6% b.f., which achieves the same whitening effect as whole milk in 70% of the volume.

In each of the sample calculations, the composition fat content may be calculated as follows:

F_{T}=F_{C}×Q_{C}+F_{M}×Q_{M}.

In this calculation using skim milk and half-and-half cream, F_{C}=10%, Q_{C}=45.8% (or 0.458 L), F_{M}=0.1% and Q_{M}=50% (or 0.5 L). Thus, the total fat in 1 L of such a composition can be calculated as F_{T}=(10%×0.458 L)+(0.1%×050 L)=4.63%, which is the same as the fat content of the milk to be replaced (3.25% for whole milk) divided by the target volume of 70% (or 0.7). This may be calculated as follows:

F_{T}=3.25%÷0.70%=4.6%.

Similarly, a variety of choices of ingredients are available for formulating other milk compositions, such as skim, or partially skimmed milks. Cream replacements may also be formulated in this way, so that the total fat content of the composition is calculated as:

Total fat of composition=[butter fat content of the selected cream]÷[target volume].

For example, the method of formulating such a composition may comprise combining from 1 to 90% wt/wt of the composition as cream; from 1 to 90% wt/wt of the composition as milk; and from 1 to 30% wt/wt of the composition as serum solids.

In one embodiment of the invention, a cream composition that includes a higher butter fat content and a higher total non-fat solids content (the sum of the “serum solids” plus non-fat solids from the milk and cream components) than the cream to be replaced is provided, thereby allowing a smaller volume to be dispensed into a cup of coffee in order to achieve the same whitening effect and the same butter fat content as 18% b.f. cream. Cream and milk provide the fluid, butter fat, and some serum solids content. Serum solids, such as from skim milk powder, provides remaining total non-fat solids required.

Possible lacteal (milk-based) ingredients for formulating a composition according to the invention include raw cream or “high fat cream” (at 41% b.f., 49.9% total solids); whipping cream or “heavy cream” (at 35% b.f.); table cream also referred to as “coffee cream” (at 18% b.f.); half-and-half (at 10% b.f.); light cream (5% b.f.); whole milk (3.25% b.f.); partially skimmed milk having 2% or 1% b.f., skim milk (0.1% b.f.), and skim milk powder. These ingredients are readily purchased but other creams or milks having different, un-conventional, percentages of butter fat may be used. Non-lacteal ingredients may be used in the serum solids component, such as soy-based non-fat solids.

A cream stabilizer may be added to the composition. Possible stabilizers for use with the invention include coffee cream stabilizer CC471 (Continental Custom Ingredients, Oakville, Canada), which includes sodium citrate, disodium phosphate, carrageenan, and dextrose; coffee cream stabilizer Germantown Salvo (Danisco, Scarborough, Canada), containing sodium citrate, sodium phosphate, carrageenan, locust bean gum, and dextrose; or food grade disodium phosphate, such as provided by Astaris (St. Louis, Mo.).

In addition to being useful in reducing the volume of whitening composition versus milk used by a consumer as a minor addition (of less than 10% of the volume of the beverage to be whitened) to whiten coffee or tea, the beverage whitening compositions described herein are useful for the preparation of steamed milk for the addition in larger amounts (greater than 10% of the volume of the beverage to be whitened) to specialty coffee drinks, for example lattes. Steamed milk prepared using the reduced-volume beverage whitening compositions described herein results in hot, frothy milk that advantageously compensates, when added to whiten the coffee, tea, or chocolate beverage, for additional dilution due to input of water volume derived from steam. Thus a more flavorful beverage can be made when whitened with the composition described herein upon steaming.

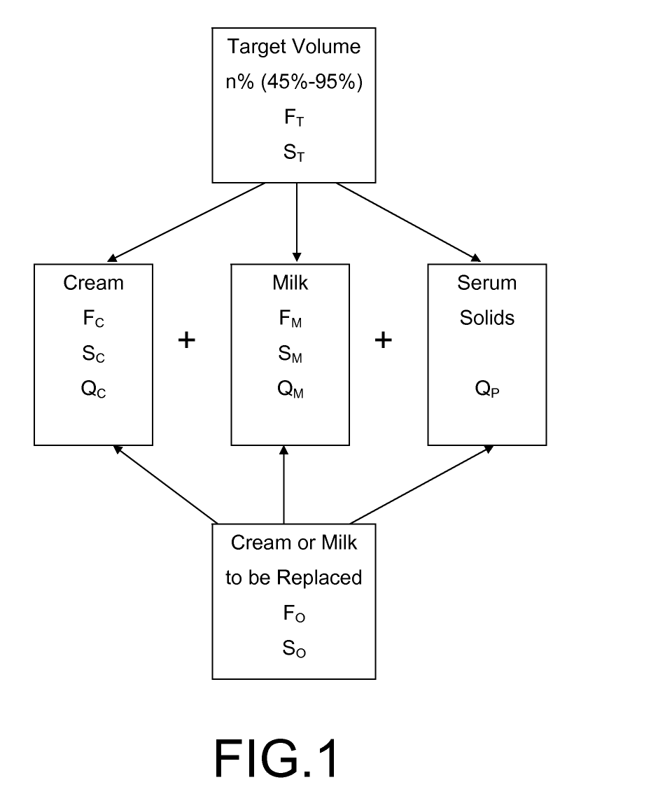

FIG. 1 is a graphic depiction of parameters to be considered according to an embodiment of the invention. A target volume is selected by the individual formulating the composition, based on need and requirements for a particular use, such as for adding milk to coffee from an automatic dispenser in a high volume coffee shop. The target volume is expressed as a percentage “n %” of the 100% conventional milk or cream that the composition is to replace in a smaller volume. The target volume is selected as from 45% to 95% of the volume that would be required if conventional milk was used. F_{T} represents the total fat in the composition, once formulated, and S_{T} represents the total serum solids present in the composition, once formulated, which are also determined based on the target volume and upon other factors, such as the selected milk to be replaced. Total serum solids need not be identically scaled up to match the increase in total fat, but in general is also increased in the composition as compared with the milk (or cream) to be replaced.

The three components to be combined are shown here as cream, milk, and serum solids. Optionally, a stabilizer can be added as well. Each of the cream and milk components have a fat content F_{C} and F_{M}, a serum solids component, S_{C} and S_{M} and a quantity or volume Q_{C} and Q_{M} that is determined by the individual formulating the composition to achieve a composition that emulates the whitening of the selected milk or cream to be replaced, but in a reduced volume (the target volume). The contribution of the serum solids component is determined and the quantity of serum solids to be added as a separate component to the composition is represented as Q_{P}. These three ingredients are added together to form the composition, to achieve the same whitening effect as the cream or milk to be replaced, which has a fat content of F_{O} and a serum solids content of S_{O}. Typically, F_{O} for milks to be replaced will be 0.1% (for skim milk), 1% or 2% for partially skimmed milks, and 3.25% for whole milk, but other less conventional, intermediate, values may be used which are lower than 5% butter fat (which is effectively considered as cream). The typical serum solids content of conventional milks to be replaced (S_{O}) may be, for example, 10%. For creams, the fat content of F_{O} could range from 5% to 35%, and the conventional categories of light cream (5%), half-and-half cream (10%), coffee cream (18%), whipping cream or table cream (35%) are exemplary values. The serum solids content of such creams may range around 10%, but may be less when fat content increases. The depicted representation of FIG. 1 is provided to show the combination of the cream, milk, and serum solids ingredients in the composition, each of which contributes to total fat and/or total serum solids of the composition.

### Example 1

### Composition for Replacement of 18% b.f. Cream

A cream-based composition is provided which contains (% wt/wt): 30% whole milk (3.25% b.f.); 67% cream (42% b.f.); 2.7% skim milk powder; and 0.3% stabilizers. This composition is concentrated in both butter fat and serum solids, relative to the 18% cream to be replaced, and achieves a target volume of 60% of the 18% b.f. cream it is designed to replace. In other words, 600 mL of the composition will have the beverage whitening ability of 1 Litre of the 18% cream to be replaced. To state this in yet another way, the composition allows about a 40% reduction in the amount of cream dispensed, while achieving good consumer acceptance. A corresponding 40% reduction in the frequency of cream bag replacement in a cream dispenser is realized.

To prepare the composition, dry ingredients were pre-hydrated in approximately the equivalent quantity of whole milk using a lab-scale Silverson high-speed mixer at 5500 rpm for about 5 minutes total mixing time. Following this, the pre-hydrated ingredients were slowly added to the remaining ingredients in a 40 L milk can and mixed for approximately 5 minutes using a pilot-scale Silverson high-speed mixer. All heavy cream samples were processed on a Microthermics HTST/UHT unit by pre-heating to 60° C., and homogenized at 1500 PST (first stage), then at 500 PSI (second stage). The homogenized composition was then pasteurized at 80° C./30 seconds, and immediately cooled to approximately 14° C. Samples were packed into 10 L Schole™ bags and refrigerated.

The resulting product contained 28.92% b.f. A contribution of 12 g of this composition to an 8 oz cup of coffee resulted in 0.49 g protein, 1.28 g of total non-fat solids, and the coffee had a pH of 5.86. Relative to the control, consisting of 18 g of 18% b.f. table cream, the contributions were nearly identical, with 0.49 g protein, 1.25 g milk solids (non-fat) and a pH of 5.85.

The Zahn cup measurement test for coffee whitened according to this example resulted in a measurement of 21.9 sec at 3° C. The control measurement was 18.5 sec at 6° C. The color measurements for whitened coffee was 48.1 (L); 4.8 (a) and 20.3 (b), versus 52.7 (L); 4.2 (a) and 20.3 (b) for the control. Fat globule size in the whitened coffee was 1.93 μm using the composition; and 0.78 μm for the control, which was still deemed within the realm of consumer acceptability. The particle size distribution in terms of specific surface area (m²/mL) was 7.57 for coffee whitened using the composition, versus 10.37 for the control. Overall, these values illustrate the acceptability of the inventive composition as a beverage whitener. The whitening ability is considered adequately similar in the composition versus control to achieve consumer acceptability.

### Example 2

### Composition for Replacement of 18% b.f. Cream

A cream-based composition is provided which contains (% wt/wt): 28% skim milk; 69% cream (42% b.f.); 2.7% skim milk powder; and 0.3% stabilizers. This composition is concentrated in both butter fat and total non-fat solids. The target volume for the composition is about 60% of the original volume of 18% b.f. cream. This allows about a 40% reduction in the amount of cream dispensed, while providing good consumer acceptance.

To prepare the composition, dry ingredients were pre-hydrated in approximately the equivalent quantity of skim milk using a lab-scale Silverson high-speed mixer at 5500 rpm for about 5 minutes total mixing time. Following this, the pre-hydrated ingredients were slowly added to the remaining ingredients in a 40 L milk can and mixed for approximately 5 minutes using a pilot-scale Silverson high-speed mixer. All heavy cream samples were processed on a Microthermics HTST/UHT unit by pre-heating to 60° C., and homogenized at 1500 PST (first stage), then at 500 PSI (second stage). The homogenized composition was then pasteurized at 80° C./30 seconds, and immediately cooled to approximately 14° C. Samples were packed into 10 L Schole™ bags and refrigerated.

The resulting product contained 28.92% b.f., and a contribution of 12 g of this composition to an 8 oz cup of coffee resulted in 0.49 g protein, 1.29 g of total non-fat solids, and the resulting whitened coffee had a pH of 5.86. Relative to the control, consisting of 18 g of 18% table cream, the contributions were nearly identical, with 0.49 g protein, 1.25 g milk solids (non-fat) and a pH of 5.85.

The Zahn cup measurement test for coffee whitened according to this example resulted in a measurement of 23.4 sec at 3° C. The control measurement was 18.5 sec at 6° C. The color measurements for whitened coffee was 46.4 (L); 5.4 (a) and 20.5 (b), versus 52.7 (L); 4.2 (a) and 20.3 (b) for the control. Fat globule size in the test whitened coffee was 1.61 μm using the composition; and 0.78 μm for the control, which was deemed within the realm of consumer acceptability. The particle size distribution in terms of specific surface area (m²/mL) was 7.47 for coffee whitened using the test composition, versus 10.37 for the control. Overall, these values illustrate the acceptability of the inventive composition as a beverage whitener. The whitening ability of the test composition was deemed to be adequate to replace 18% b.f. cream with good consumer acceptance.

### Example 3

### Composition for Replacement of Whole Milk in 75% of the Volume

A milk-based reduced-volume composition is provided which contains (% wt/wt): 54% skim milk (0.1 b.f.); 42% half and half cream (10% b.f.); 3.7% skim milk powder; and 0.3% stabilizers. This composition is concentrated in both butter fat and serum solids, relative to the whole milk to be replaced, and achieves the same whitening in a target volume of 75% of the whole milk it is designed to replace. In other words, 750 mL of the composition will have the beverage whitening ability of 1 Litre of the 3.25% b.f. whole milk to be replaced. To state this in yet another way, the composition allows about a 25% reduction in the amount of milk dispensed, while achieving good consumer acceptance. A corresponding 25% reduction in the frequency of milk bag replacement in a milk dispenser is realized. The milk based compositions are useful for the preparation of steamed milk for the addition to specialty coffee drinks, for example lattes. Steamed milk prepared using this reduced-volume composition results in hot, frothy milk that does not dilute the coffee, tea, or chocolate beverage due to increases in water volume upon steam input.

To prepare the composition, dry ingredients are pre-hydrated in approximately the equivalent quantity of whole milk using a lab-scale Silverson high-speed mixer at 5500 rpm for about 5 minutes total mixing time. Following this, the pre-hydrated ingredients are slowly added to the remaining ingredients in a 40 L milk can and mixed for approximately 5 minutes using a pilot-scale Silverson high-speed mixer. All heavy cream samples may be processed on a Microthermics HTST/UHT unit by pre-heating to 60° C., and homogenized at 1500 PST (first stage), then at 500 PSI (second stage). The homogenized composition can then be pasteurized at 80° C./30 seconds, and immediately cooled to approximately 14° C. Samples can be packed into 10 L Schole™ bags and refrigerated.

The resulting composition contains 4.25% b.f. and a total of 13% serum solids (from all ingredients), as compared with conventional whole milk to be replaced, which contains 3.25% b.f., and about 10% serum solids.

### Example 4

### Composition for Replacement of Whole Milk in 65% of the Volume

A composition is provided which contains (% wt/wt): 68% skim milk (0.1% b.f.); 27% coffee cream (18% b.f.); 4.7% skim milk powder; and 0.3% stabilizers. This composition is concentrated in both butter fat and serum solids, relative to the whole milk to be replaced, and achieves the same whitening effect as whole milk in a target volume of 65% of the conventional whole milk it is designed to replace. In other words, 650 mL of the composition will have the beverage whitening ability of 1 Litre of the 3.25% milk to be replaced. To state this in yet another way, the composition allows about a 35% reduction in the amount of milk dispensed, while achieving good consumer acceptance. A corresponding 35% reduction in the frequency of milk bag replacement in a milk dispenser is realized.

The composition is prepared according to the method described above in Examples 1-3. The resulting composition contains about 5% b.f. and a total of about 14% serum solids (from all ingredients).

### Example 5

### Composition for Replacement of Whole Milk in 65% of the Volume

An additional exemplary composition is a reduced-volume whole milk replacement composition, for replacement of conventional whole milk comprising about 3.25% butter fat in a target volume of 65%. Thus, 65 mL of this whole milk replacement composition possesses the whitening ability of 100 mL of conventional whole milk. The composition comprises 76% partially skimmed 2% milk (containing 2% wt/wt butter fat), 19% “coffee cream” (containing 18% wt/wt butter fat), 4.7% wt/wt serum solids, and 0.3% wt/wt stabilizer. In this way, this reduced-volume whole milk replacement composition has the whitening effect of conventional whole milk in a target volume that is about 65% of the volume of the milk to be replaced.

This reduced-volume whole milk replacement composition comprises about 4.9% wt/wt butter fat (compared with conventional whole milk containing 3.25%) and 14% (wt/wt) serum solids. Specifically: 4.7 g serum solids/100 g of composition is contributed by direct addition of serum solids, 7.6 g serum solids/100 g of composition is contributed by the partially skimmed 2% milk component, and 1.5 g serum solids/100 g of composition is contributed by the cream component. These values are based on partially skimmed 2% milk comprising about 10% serum solids while cream containing 18% butter fat comprises about 8% serum solids. Thus, the target volume for this reduced-volume whole milk replacement composition is about 65%.

### Example 6

### Composition for Replacement of Partially Skimmed 2% Milk in 80% of the Volume

A composition is formulated to contain (% wt/wt) 84% skim milk (containing 0.1% wt/wt butter fat), 13.1% coffee cream (containing 18% wt/wt butter fat), 2.7% wt/wt serum solids, and 0.2% wt/wt stabilizer. In this way, the reduced-volume partially skimmed 2% milk replacement composition has the whitening effect of commercial 2% milk in a target volume of 80% of the volume of the partially skimmed 2% milk to be replaced.

This reduced-volume partially skimmed 2% milk replacement composition comprises about 2.4% wt/wt butter fat (compared with conventional partially skimmed milk containing 2%) and 12.1% (wt/wt) serum solids. Specifically: 2.7 g serum solids/100 g of composition is contributed by direct addition of serum solids, 8.4 g serum solids/100 g of composition is contributed by the skim milk component, and 1.07 g serum solids/100 g of composition is contributed by the cream component. Thus, the target volume for this reduced-volume partially skimmed 2% milk replacement composition is 80%.

### Example 7

### Composition for Replacement of Partially Skimmed 2% Milk in 60% of the Volume

A composition is provided which contains (% wt/wt): 67% light cream (5.0% b.f.); 28% skim milk (0.1% b.f.); 4.7% skim milk powder; and 0.3% stabilizers. This composition is concentrated in both butter fat and serum solids, relative to the partially skimmed 2% milk to be replaced, and achieves the same whitening effect as partially skimmed 2% milk in a target volume of 60% of the milk it is designed to replace. In other words, 600 mL of the composition will have the beverage whitening ability of 1 Litre of the partially skimmed 2% milk to be replaced. To state this in yet another way, the composition allows about a 40% reduction in the amount of milk dispensed, while achieving good consumer acceptance. A corresponding 40% reduction in the frequency of milk bag replacement in a milk dispenser is realized.

The composition is prepared according to the method described above in Examples 1-3. The resulting composition contains about 3.3% b.f. and a total of about 16% serum solids (from all ingredients).

### Example 8

### Composition for Replacement of Partially Skimmed 2% Milk in 55% of the Volume

An exemplary composition is provided as a reduced-volume partially skimmed 2% milk replacement composition, for replacement of conventional 2% butter fat milk in a target volume of 55%. Thus, 55 mL of this partially skimmed 2% milk replacement composition possesses the whitening ability of 100 mL of conventional partially skimmed 2% milk. The composition comprises 77% partially skimmed 1% milk (containing 1% wt/wt butter fat), 16% “coffee cream” (containing 18% wt/wt butter fat), 6.7% wt/wt serum solids, and 0.3% wt/wt stabilizer. In this way, this reduced-volume partially skimmed 2% milk replacement composition has the whitening effect of conventional partially skimmed 2% milk in a target volume that is about 55% of the volume of the milk to be replaced.

This reduced-volume partially skimmed 2% milk replacement composition comprises about 3.6% wt/wt butter fat (compared with conventional partially skimmed 2% milk containing 2%) and 16% (wt/wt) serum solids. Specifically: 6.7 g serum solids/100 g of composition is contributed by direct addition of serum solids, 7.6 g serum solids/100 g of composition is contributed by the partially skimmed 1% milk component, and 1.3 g serum solids/100 g of composition is contributed by the cream component. These values are based on partially skimmed 1% milk comprising about 10% serum solids while cream containing 18% butter fat comprises about 8% serum solids. Thus, the target volume for this partially skimmed 2% milk replacement composition is about 55%.

### Example 9

### Composition for Replacement of Partially Skimmed 1% Milk in 70% of the Volume

Another exemplary composition is a reduced-volume partially skimmed 1% milk replacement composition, for replacement of conventional 1% butter fat milk in a target volume of 70%. Thus, 70 g of this partially skimmed milk replacement composition possesses the whitening ability of 100 g of conventional partially skimmed 1% milk. The composition comprises 82% skim milk (containing 0.1% wt/wt butter fat), 14% “half and half” cream (containing 10% wt/wt butter fat), 3.7% wt/wt serum solids, and 0.3% wt/wt stabilizer. In this way, this reduced-volume partially skimmed 1% milk replacement composition has the whitening effect of conventional partially skimmed 1% milk in a target volume that is about 70% of the volume of the milk to be replaced.

This reduced-volume partially skimmed 1% milk replacement composition comprises about 1.4% wt/wt butter fat (compared with conventional partially skimmed 1% milk containing 1%) and 13% (wt/wt) serum solids. Specifically: 3.7 g serum solids/100 g of composition is contributed by direct addition of serum solids, 8.2 g serum solids/100 g of composition is contributed by the skim milk component, and 1.2 g serum solids/100 g of composition is contributed by the cream component. These values are based on skim milk comprising about 10% serum solids while cream containing 10% butter fat comprises about 9% serum solids. Thus, the target volume for this reduced-volume partially skimmed 1% milk replacement composition is about 70%.

### Example 10

### Composition for Replacement of Partially Skimmed 1% Milk in 65% of the Volume

A composition is formulated to contain (% wt/wt) 79% skim milk (containing 0.1% wt/wt butter fat), 15% half-and-half cream (containing 10% wt/wt butter fat), 5.7% wt/wt serum solids, and 0.3% wt/wt stabilizer. In this way, the reduced-volume partially skimmed 1% milk replacement composition has the whitening effect of commercial 1% milk in a target volume of 65% of the volume of the partially skimmed 1% milk to be replaced.

This reduced-volume partially skimmed 1% milk replacement composition comprises about 1.5% wt/wt butter fat (compared with conventional partially skimmed milk containing 1%) and 14.9% (wt/wt) serum solids. Specifically: 5.7 g serum solids/100 g of composition is contributed by direct addition of serum solids, 7.9 g serum solids/100 g of composition is contributed by the skim milk component, and 1.35 g serum solids/100 g of composition is contributed by the cream component. Thus, the target volume for this reduced-volume partially skimmed 1% milk replacement composition is 65%.

### Example 11

### Composition for Replacement of Partially Skimmed 1% Milk in 55% of the Volume

A composition is formulated to contain (% wt/wt) 75% skim milk (containing 0.1% wt/wt butter fat), 17.7% half-and-half cream (containing 10% wt/wt butter fat), 7% wt/wt serum solids, and 0.3% wt/wt stabilizer. In this way, the reduced-volume partially skimmed 1% milk replacement composition has the whitening effect of commercial 1% milk in a target volume of 55% of the volume of the partially skimmed 1% milk to be replaced.

This reduced-volume partially skimmed 1% milk replacement composition comprises about 1.8% wt/wt butter fat (compared with conventional partially skimmed milk containing 1%) and 16% (wt/wt) serum solids. Specifically: 7 g serum solids/100 g of composition is contributed by direct addition of serum solids, 7.4 g serum solids/100 g of composition is contributed by the skim milk component, and 1.6 g serum solids/100 g of composition is contributed by the cream component. Thus, the target volume for this reduced-volume partially skimmed 1% milk replacement composition is 55%.

### Example 12

### Composition for Replacement of Partially Skimmed 1.5% Milk in 77% of the Volume

While 1.5% butter fat content is not a conventional milk formulation, this example is provided to illustrate how a butter fat content intermediate between the conventional partially skimmed milk values of 1% and 2% milk can be determined as the content of the selected milk to be replaced. A composition is formulated to contain (% wt/wt) 84% partially skimmed milk (containing 1% wt/wt butter fat), 11.7% half-and-half cream (containing 10% wt/wt butter fat), 4% wt/wt serum solids, and 0.3% wt/wt stabilizer. In this way, the reduced-volume partially skimmed 1.5% milk replacement composition has the whitening effect of 1.5% milk in a target volume of 77% of the volume of the partially skimmed 1.5% milk to be replaced.

This reduced-volume partially skimmed 1.5% milk replacement composition comprises about 2% wt/wt butter fat (compared with the selected partially skimmed milk to be replaced containing 1.5%) and 13% (wt/wt) serum solids. Specifically: 4 g serum solids/100 g of composition is contributed by direct addition of serum solids, 8.3 g serum solids/100 g of composition is contributed by the 1% milk component, and 1 g serum solids/100 g of composition is contributed by the cream component. Thus, the target volume for this reduced-volume partially skimmed 1% milk replacement composition is 77%.

### Example 13

### Composition for Replacement of Partially Skimmed 1% Milk in 80% of the Volume

A composition is formulated to contain (% wt/wt) 90% partially skimmed milk (containing % wt/wt butter fat), 7.8% light cream (containing 5% wt/wt butter fat), 2% wt/wt serum solids, and 0.2% wt/wt stabilizer. In this way, the reduced-volume partially skimmed 1% milk replacement composition has the whitening effect of commercial 1% milk in a target volume of 80% of the volume of the partially skimmed 1% milk to be replaced.

This reduced-volume partially skimmed 1% milk replacement composition comprises about 1.3% wt/wt butter fat (compared with conventional partially skimmed milk containing 1%) and 11.6% (wt/wt) serum solids. Specifically: 2 g serum solids/100 g of composition is contributed by direct addition of serum solids, 8.9 g serum solids/100 g of composition is contributed by the partially skimmed 1% milk component, and 0.74 g serum solids/100 g of composition is contributed by the cream component. Thus, the target volume for this reduced-volume partially skimmed 1% milk replacement composition is 80%.

### Example 14

### Composition for Replacement of Skim Milk in 85% of the Volume

A composition is formulated to contain (% wt/wt): 97.3% skim milk (containing 0.1% wt/wt butter fat), 0.4% cream (containing 5% wt/wt butter fat), 2% wt/wt serum solids, and 0.3% wt/wt stabilizer. In this way, the reduced-volume skim milk replacement composition has the whitening effect of commercial skim milk in a target volume of 85% of the volume of the skim milk to be replaced.

This reduced-volume skim milk replacement composition comprises about 0.117% wt/wt butter fat (compared with conventional skim milk containing 0.1%) and 11.8% (wt/wt) serum solids. Specifically: 2 g serum solids/100 g of composition is contributed by direct addition of serum solids, 9.7 g serum solids/100 g of composition is contributed by the skim milk component, and 0.04 g serum solids/100 g of composition is contributed by the cream component. Thus, the target volume for this reduced-volume skim milk replacement composition is 85%.

### Example 15

### Composition for Replacement of Skim Milk in 80% of the Volume

A composition is formulated to contain (% wt/wt): 96.6% skim milk (containing 0.1% wt/wt butter fat), 0.6% cream (containing 5% wt/wt butter fat), 2.5% wt/wt serum solids, and 0.3% wt/wt stabilizer. In this way, the reduced-volume skim milk replacement composition has the whitening effect of commercial skim milk in a target volume of 80% of the volume of the skim milk to be replaced.

This reduced-volume skim milk replacement composition comprises about 0.127% wt/wt butter fat (compared with conventional skim milk containing 0.1%) and 12.2% (wt/wt) serum solids. Specifically: 2.5 g serum solids/100 g of composition is contributed by direct addition of serum solids, 9.6 g serum solids/100 g of composition is contributed by the skim milk component, and 0.06 g serum solids/100 g of composition is contributed by the cream component. Thus, the target volume for this reduced-volume skim milk replacement composition is 80%.

### Example 16

### Composition for Replacement of Skim Milk in 67% of the Volume

This composition is a reduced-volume skim milk replacement composition. The composition comprises 94% skim milk (containing 0.1% wt/wt butter fat), 1% cream (containing 5% wt/wt butter fat), 4.7% wt/wt serum solids, and 0.3% wt/wt stabilizer. In this way, the reduced-volume skim milk replacement composition has the whitening effect of commercial skim milk in a target volume that is about ⅔ (67%) of the volume of the skim milk to be replaced.

This reduced-volume skim milk replacement composition comprises about 0.15% wt/wt butter fat (compared with conventional skim milk containing 0.1%) and 14% (wt/wt) serum solids. Specifically: 4.7 g serum solids/100 g of composition is contributed by direct addition of serum solids, 9.4 g serum solids/100 g of composition is contributed by the skim milk component, and 0.1 g serum solids/100 g of composition is contributed by the cream component. These values are based on skim milk comprising about 10% serum solids while cream containing 5% butter fat comprises about 9.5% serum solids. Thus, the target volume for this reduced-volume skim milk replacement composition is about 67%.

### Example 17

### Composition for Replacement of Skim Milk in 75% of the Volume

A composition is formulated to contain (% wt/wt): 95.4% skim milk (containing 0.1% wt/wt butter fat), 0.8% cream (containing 5% wt/wt butter fat), 3.5% wt/wt serum solids, and 0.3% wt/wt stabilizer. In this way, the reduced-volume skim milk replacement composition has the whitening effect of commercial skim milk in a target volume of 75% of the volume of the skim milk to be replaced.

This reduced-volume skim milk replacement composition comprises about 0.135% wt/wt butter fat (compared with conventional skim milk containing 0.1%) and 13.1% (wt/wt) serum solids. Specifically: 3.5 g serum solids/100 g of composition is contributed by direct addition of serum solids, 9.5 g serum solids/100 g of composition is contributed by the skim milk component, and 0.08 g serum solids/100 g of composition is contributed by the cream component. Thus, the target volume for this reduced-volume skim milk replacement composition is 75%.

### Example 18

### Composition for Replacement of Skim Milk in 60% of the Volume

A composition is formulated to contain (% wt/wt): 91.3% skim milk (containing 0.1% wt/wt butter fat), 1.5% cream (containing 5% wt/wt butter fat), 6.9% wt/wt serum solids, and 0.3% wt/wt stabilizer. In this way, the reduced-volume skim milk replacement composition has the whitening effect of commercial skim milk in a target volume of 60% of the volume of the skim milk to be replaced.

This reduced-volume skim milk replacement composition comprises about 0.166% wt/wt butter fat (compared with conventional skim milk containing 0.1%) and 16% (wt/wt) serum solids. Specifically: 6.9 g serum solids/100 g of composition is contributed by direct addition of serum solids, 9.1 g serum solids/100 g of composition is contributed by the skim milk component, and 0.14 g serum solids/100 g of composition is contributed by the cream component. Thus, the target volume for this reduced-volume skim milk replacement composition is 60%.

### Example 19

### Composition for Replacement of Skim Milk in 55% of the Volume

A composition is formulated to contain (% wt/wt): 88.7% skim milk (containing 0.1% wt/wt butter fat), 2% cream (containing 5% wt/wt butter fat), 9.0% wt/wt serum solids, and 0.3% wt/wt stabilizer. In this way, the reduced-volume skim milk replacement composition has the whitening effect of commercial skim milk in a target volume of 55% of the volume of the skim milk to be replaced.

This reduced-volume skim milk replacement composition comprises about 0.189% wt/wt butter fat (compared with conventional skim milk containing 0.1%) and 18% (wt/wt) serum solids. Specifically: 9 g serum solids/100 g of composition is contributed by direct addition of serum solids, 8.9 g serum solids/100 g of composition is contributed by the skim milk component, and 0.19 g serum solids/100 g of composition is contributed by the cream component. Thus, the target volume for this reduced-volume skim milk replacement composition is 55%.

### Example 20

### Composition for Replacement of Half-and-Half (10% Bf) Cream in 75% of the Volume

A composition is formulated to contain (% wt/wt): 59% skim milk (containing 0.1% wt/wt butter fat), 37.8% “whipping” cream (containing 35% wt/wt butter fat), 3.0% wt/wt serum solids, and 0.2% wt/wt stabilizer. In this way, the reduced-volume half-and-half cream replacement composition has the whitening effect of commercial half-and-half cream in a target volume of 75% of the volume of the half-and-half cream to be replaced.

This reduced-volume half-and-half cream replacement composition comprises about 13.3% wt/wt butter fat (compared with conventional half-and-half cream containing 10%) and 11.3% (wt/wt) serum solids. Specifically: 3 g serum solids/100 g of composition is contributed by direct addition of serum solids, 5.8 g serum solids/100 g of composition is contributed by the skim milk component, and 2.4 g serum solids/100 g of composition is contributed by the cream component. Thus, the target volume for this reduced-volume half-and-half cream replacement composition is 75%.

### Example 21

### Composition for Replacement of Light Cream in 60% of the Volume

A composition is formulated to contain (% wt/wt): 56% partially skimmed milk (containing 2% wt/wt butter fat), 39.7% coffee cream (containing 18% wt/wt butter fat), 4% wt/wt serum solids, and 0.3% wt/wt stabilizer. In this way, the reduced-volume light cream replacement composition has the whitening effect of commercial light cream in a target volume of 60% of the volume of the light cream to be replaced.

This reduced-volume light cream replacement composition comprises about 8.3% wt/wt butter fat (compared with conventional light cream containing 5%) and 12% (wt/wt) serum solids. Specifically: 4 g serum solids/100 g of composition is contributed by direct addition of serum solids, 8.9 g serum solids/100 g of composition is contributed by the milk component, and 3.2 g serum solids/100 g of composition is contributed by the cream component. Thus, the target volume for this reduced-volume light cream replacement composition is 60%.

The above-described embodiments of the present invention are intended to be examples only. Alterations, modifications and variations may be effected to the particular embodiments by those of skill in the art without departing from the scope of the invention, which is defined solely by the claims appended hereto.

1. A beverage whitening composition for replacing a selected milk in a target volume of from 45-95% of the selected milk to be replaced, wherein the beverage to be whitened is coffee, tea, or hot chocolate; and the selected milk to be replaced has a butter fat content of from 0.1-3.25%,
the composition consisting of:
0.5-80% by weight of cream having from 5-42% by weight butter fat;
15-97% by weight of milk having from 0.1-3.25% by weight butter fat;
serum solids; and
optionally a stabilizer;
wherein the butter fat content of the composition is greater than the butter fat content of the selected milk to be replaced, and is calculated as:
[butter fat content of the selected milk]/[target volume];
wherein the beverage whitening composition has the beverage whitening ability of the selected milk to be replaced when added to the beverage in the target volume of from 45-95% of the volume of the selected cream or milk to be replaced.

2. The composition of claim 1 wherein the butter fat content (F_{T}) by weight % of the composition is calculated as:
F_{T}=F_{C}×Q_{C}+F_{M}×Q_{M}
wherein F_{C} is the % wt/wt butter fat content of the cream, Q_{C} is the portion by weight % of the composition attributable to cream, F_{M} is the % wt/wt butter fat content of the milk, and Q_{M} is the portion by weight % of the composition attributable to milk.

3. The composition of claim 1 wherein total non-fat solids content (S_{T}) by weight % of the composition is calculated as:
S_{T}=S_{C}×Q_{C}+S_{M}×Q_{M}+Q_{P}
wherein S_{C} is the % wt/wt non-fat milk solids content of the cream, Q_{C} is the portion by weight % of the composition attributable to cream, S_{M} is the % wt/wt non-fat milk solids content of the milk, Q_{M} is the portion by weight % of the composition attributable to milk, and Q_{P} is the portion by weight % of the composition attributable to serum solids.

4. The composition of claim 1, wherein the selected milk to be replaced is skim milk, partially skimmed milk, or whole milk.

5. The composition of claim 1 wherein:
(a) the selected milk to be replaced is skim milk having a butter fat content of 0.1% wt/wt, and the composition consists of 0.5-2.0% by weight of cream having 5% by weight butter fat; 88-97% by weight of milk having 0.1% by weight butter fat;
serum solids; and optionally a stabilizer;
(b) the selected milk to be replaced is partially skimmed milk having a butter fat content of 1% wt/wt, and the composition consists of 5-25% by weight of cream having from 5-42% by weight butter fat; 70-95% by weight of milk having from 0.1-2% by weight butter fat; serum solids; and optionally a stabilizer;
(c) the selected milk to be replaced is partially skimmed milk having a butter fat content of 2% wt/wt, and the composition consists of 3-70% by weight of cream having from 5-42% by weight butter fat; 55-95% by weight of milk having from 0.1-3.25% by weight butter fat; serum solids; and optionally a stabilizer; or
(d) the selected milk to be replaced is whole milk having a butter fat content of 3.25% wt/wt, and the composition consists of 3-80% by weight of cream having from 5-42% by weight butter fat; 15-95% by weight of milk having from 0.1-3.25% by weight butter fat; serum solids; and optionally a stabilizer.

6. The composition of claim 1 wherein the target volume is from 60 to 85% of the volume of the selected milk to be replaced.

7. The composition of claim 1 wherein the stabilizer is present in the composition in an amount of from about 0.2 to 0.4% by weight.

8. The composition of claim 5 wherein the selected milk to be replaced is skim milk, the target volume is 60-85%.

9. The composition of claim 5 wherein the selected milk to be replaced is partially skimmed milk having a butter fat content of 1% wt/wt, and the target volume is 60-85%.

10. The composition of claim 5 wherein the selected milk to be replaced is partially skimmed milk having a butter fat content of 2% wt/wt, and the target volume is 60-85%.

11. The composition of claim 5 wherein the selected milk to be replaced is whole milk having a butter fat content of 3.25% wt/wt, and the target volume is 60-85%.

12. A method of whitening a beverage comprising coffee, tea, or hot chocolate, said method comprising adding to the beverage the composition of claim 1.

13. A method of formulating a beverage whitening composition for replacing a selected milk in a target volume of from 45-95% of the selected milk to be replaced, wherein the beverage to be whitened is coffee, tea, or hot chocolate; and the selected milk to be replaced has a butter fat content of from 0.1-3.25%, said method comprising:
determining the selected milk to be replaced; and
forming, in the target volume of from 45% to 95% of the selected milk to be replaced, the composition consisting of:
0.5-80% by weight of cream having from 5-42% by weight butter fat;
15-97% by weight of milk having from 0.1-3.25% by weight butter fat;
serum solids; and
optionally a stabilizer;
wherein the butter fat content of the composition is greater than the butter fat content of the selected milk to be replaced, and is calculated as:
[butter fat content of the selected milk]/[target volume];
wherein the beverage whitening composition has the beverage whitening ability of the selected milk to be replaced when added to the beverage in the target volume of from 45-95% of the volume of the selected cream or milk to be replaced.

14. The method of claim 13, wherein the target volume is from 60% to 85%.

15. The method of claim 13 wherein:
(a) the selected milk to be replaced is skim milk having a butter fat content of 0.1% wt/wt, and the composition consists of 0.5-2.0% by weight of cream having 5% by weight butter fat; 88-97% by weight of milk having 0.1% by weight butter fat; serum solids; and optionally a stabilizer;
(b) the selected milk to be replaced is partially skimmed milk having a butter fat content of 1% wt/wt, and the composition consists of 5-25% by weight of cream having from 5-42% by weight butter fat; 70-95% by weight of milk having from 0.1-2% by weight butter fat; serum solids; and optionally a stabilizer;
(c) the selected milk to be replaced is partially skimmed milk having a butter fat content of 2% wt/wt, and the composition consists of 3-70% by weight of cream having from 5-42% by weight butter fat; 55-95% by weight of milk having from 0.1-3.25% by weight butter fat; serum solids; and optionally a stabilizer; or
(d) the selected milk to be replaced is whole milk having a butter fat content of 3.25% wt/wt, and the composition consists of 3-80% by weight of cream having from 5-42% by weight butter fat; 15-95% by weight of milk having from 0.1-3.25% by weight butter fat; serum solids; and optionally a stabilizer.

16. The method of claim 15 wherein the selected milk to be replaced is skim milk, the target volume is 60-85%.

17. The method of claim 15 wherein the selected milk to be replaced is partially skimmed milk having a butter fat content of 1% wt/wt, and the target volume is 60-85%.

18. The method of claim 15 wherein the selected milk to be replaced is partially skimmed milk having a butter fat content of 2% wt/wt, and the target volume is 60-85%.

19. The method of claim 15 wherein the selected milk to be replaced is whole milk having a butter fat content of 3.25% wt/wt, and the target volume is 60-85%.

20. A method of whitening a beverage by replacing a selected milk to be replaced by a beverage whitening composition in a target volume of from 45-95% of the selected milk to be replaced, wherein the beverage is coffee, tea, or hot chocolate, said method comprising adding to the beverage the beverage whitening composition consisting of:
0.5-80% by weight of cream having from 5-42% by weight butter fat;
15-97% by weight of milk having from 0.1-3.25% by weight butter fat;
serum solids; and
optionally a stabilizer;
wherein the butter fat content of the composition is greater than the butter fat content of the selected milk to be replaced, and is calculated as:
[butter fat content of the selected milk]/[target volume];
wherein the beverage whitening composition has the beverage whitening ability of the selected milk to be replaced when added to the beverage in the target volume of from 45-95% of the volume of the selected cream or milk to be replaced.

21. The method of claim 20 wherein:
(a) the selected milk to be replaced is skim milk having a butter fat content of 0.1% wt/wt, and the composition consists of 0.5-2.0% by weight of cream having 5% by weight butter fat; 88-97% by weight of milk having 0.1% by weight butter fat; serum solids; and optionally a stabilizer;
(b) the selected milk to be replaced is partially skimmed milk having a butter fat content of 1% wt/wt, and the composition consists of 5-25% by weight of cream having from 5-42% by weight butter fat; 70-95% by weight of milk having from 0.1-2% by weight butter fat; serum solids; and optionally a stabilizer;
(c) the selected milk to be replaced is partially skimmed milk having a butter fat content of 2% wt/wt, and the composition consists of 3-70% by weight of cream having from 5-42% by weight butter fat; 55-95% by weight of milk having from 0.1-3.25% by weight butter fat; serum solids; and optionally a stabilizer; or
(d) the selected milk to be replaced is whole milk having a butter fat content of 3.25% wt/wt, and the composition consists of 3-80% by weight of cream having from 5-42% by weight butter fat; 15-95% by weight of milk having from 0.1-3.25% by weight butter fat; serum solids; and optionally a stabilizer.
